(19) United States
(12) Patent Application Publication
(10) Pub. No.: US 2005/0010462 A1
(43) Pub. Date: Jan. 13, 2005

(54) Knowledge management system and methods for crude oil refining

(76) Inventors: Mark Dausch, Castleton, NY (US); Helena Goldfarb, Niskayuna, NY (US); Martha Gardner, Niskayuna, NY (US); Michael Kinstrey, Ballston Spa, NY (US); Shirley Au, Mt. Laurel, NJ (US); Roy Wilson, Warrington, PA (US); Harold Eggert, The Woodlands, TX (US); Russell Strong, The Woodlands, TX (US); Malcolm C. Winslow, Houston, TX (US)

Correspondence Address: GE GLOBAL RESEARCH;DOCKET ROOM K-1/4A59, ONE RESEARCH CIRCLE, NISKAYUNA, NY, 12309, US

(21) Appl. No.: 10/615,431

(22) Filed: Jul. 7, 2003

(51) Int. Cl. G06F 17/60

(52) U.S. Cl. 705/8; 705/9

(57) ABSTRACT

A knowledge management system and methods for crude oil refining are provided. The knowledge management system and methods enable information, such as crude oil characterizations, the experiences of processing crude oils in the refinery, problems encountered during the processing of crude oil in the refinery, and the treatments applied by personnel of the refinery to counteract those problems, to be captured, organized, and disseminated. The knowledge management system and methods for crude oil refining further provide a basis for running analytical models and other decision support applications to assess risks and financial impacts; thus, allowing users to make informed decisions for crude selection and treatment planning.

### FIELD OF THE INVENTION

The present disclosure relates to the refining of crude oil, and particularly to a knowledge management system and method for crude oil refining. Specifically, the present disclosure relates to a system and methods to capture, organize, and disseminate information from refineries' production processes, crude assay information, and analytical results to support the selection of crude oils, manage risks of processing crude oils and the planning and monitoring of chemical treatments applied to the production processes.

### BACKGROUND OF THE INVENTION

Refineries are generally designed and built to handle certain types of crude oils. The selection of equipment, the material for the piping, valves, and tanks, and the arrangement of systems, subsystems, and components are specific for the types of crude oils processed by the refinery.

Crude oils can vary widely in terms of such characteristics as sulfur content, acids, heavy metals, salts, water, and other contaminants. In order to process crude oils that are significantly different from the types to which the refinery was designed or to process mixtures of crude oils typically requires extensive testing, laboratory simulations, and expensive modifications to the refinery.

Accordingly, there is a need for a knowledge management system and methods for crude oil refining.

### BRIEF DESCRIPTION OF THE INVENTION

The invention provides a knowledge management system and methods for crude oil refining. In one aspect, the knowledge management system and methods enable information, such as crude oil characterizations, the experiences of processing crude oils in the refinery, problems encountered during the processing of crude oil in the refinery, and the treatments applied by personnel of the refinery to counteract those problems, to be captured, organized, and disseminated.

The knowledge management system and methods for crude oil refining of the invention further provide a basis for running analytical models and other decision support applications to assess risks and financial impacts; thus, allowing users to make informed decisions for crude selection and treatment planning.

The refinery and crude oil knowledge management system of the invention consists of a plurality of classes or types of information stored in a knowledge base including but not limited to customer, refinery, crude unit, crude tank, slop tank, equipment, equipment configuration, equipment specification, inspection report, maintenance report, production process, product, product characteristic, crude slate, crude oil, crude oil characteristic or assay, slop, service report, non-destructive testing (NDT) data, operational data, chemical treatment, problem report, laboratory analysis, laboratory simulation, and predictive result.

In addition to providing a system for organizing the numerous classes of information, the invention prescribes methods for capturing the information, searching for information, reporting results, and updating the content.

Steps of the methods of the invention may be implemented by executing instructions by a processor, where the instructions are stored on a computer readable medium or included in a computer data signal embodied in a transmission medium.

### BRIEF DESCRIPTION OF THE DRAWING

FIG. 1 is a block diagram of an illustrative embodiment of a refinery and crude oil knowledge management system.

### DESCRIPTION OF THE PREFERRED EMBODIMENT

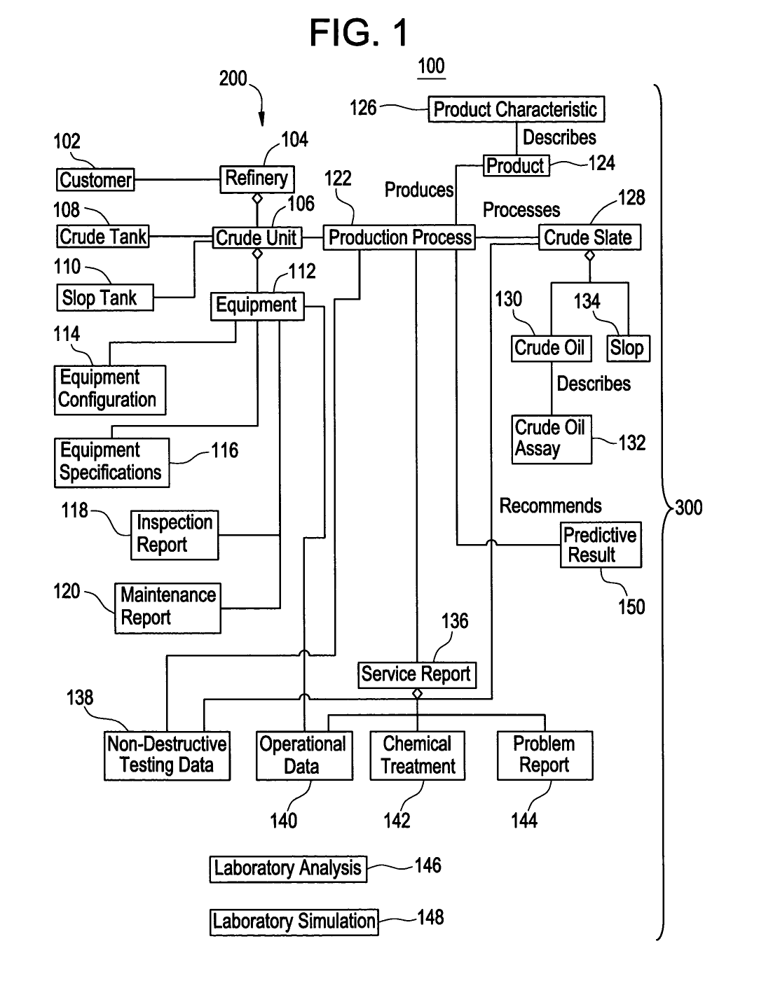

The refinery and crude oil knowledge management system of the invention is shown by FIG. 1 and designated generally by reference numeral 100. The system 100 consists of a plurality of classes or types of information stored in a knowledge base 200, such as a database or a group of interlinked databases. The databases can be local or remote with respect to each other and connected via conventional networking systems, such as a LAN, WAN, the Internet, etc.

FIG. 1 depicts these classes together with the associates or relationships that these classes may have to other classes based on a predefined hierarchical system. The various functions or methods provided for by the system 100 are further described below. The methods are performed using the information stored by the knowledge base 200 and a set of programmable instructions configured for execution by at least one processor.

The instructions or a portion thereof can be stored on the at least one processor. The instructions or a portion thereof can also be stored on a computer readable medium or included in a computer data signal embodied in a transmission medium.

One function of the system 100 and methods is to enable information, such as crude oil characterizations, the experiences of processing crude oils in the refinery, problems encountered during the processing of crude oil in the refinery, and the treatments applied by personnel of the refinery to counteract those problems, to be captured, organized, and disseminated. The information can be disseminated via printed reports, a display, and other methods of dissemination known in the art. The system 100 and methods further provide a basis for running analytical models and other decision support applications to assess risks and financial impacts; thus, allowing users to make informed decisions for crude selection and treatment planning.

As shown by FIG. 1, the classes or types of information stored in the knowledge base 200 are organized in a hierarchical system 300 and include but not limited to customer class 102, refinery class 104, crude unit class 106, crude tank class 108, slop tank class 110, equipment class 112, equipment configuration class 114, equipment specification class 116, inspection report class 118, maintenance report class 120, production process class 122, product class 124, product characteristics class 126, crude slate class 128, crude oil class 130, crude oil characteristics or assay class 132, slop class 134, service report class 136, non-destructive testing (NDT) data class 138, operational data class 140, chemical treatment class 142, problem report class 144, laboratory analysis class 146, laboratory simulation class 148, and predictive result class 150.

The highest class in the hierarchical system 300 is the production process class 122. The following describes each class or type of information in more detail.

The customer class 102 contains information relating to the owner of the refinery and may also contain the ship-to address for the chemicals used in the process treatment. The refinery class 104 provides referencing information and may consist of one or more crude units and other production processes. The crude unit class 106 contains information relating to the collection of equipment that processes the crude oils. Types of equipment include heaters, desalters, distillation columns, pumps, heat exchangers and such.

Equipment configuration class 114 contains information relating to the arrangement or configuration of systems, subsystems, and components which comprise the equipment of the refinery. Usually the equipment is configured to meet some operating objective of the refinery. For example, in the configuration for a desalter process, the crude unit may use a two staging desalting configuration. Equipment specification class 116 pertains to a class of information including design information such as engineering drawings and technical specifications related to the refinery. As previously mentioned refineries are designed for certain types of crude oils. This class captures such information. The equipment configuration class 114 and the equipment specification class 116 are types of the equipment class 112.

Crude tank class 108 is another type of the equipment class 112; however, from the system perspective, it is shown separately to indicate that inventory levels of crude may be monitored to automatically provide information on the percentage of crude oil contained in the feedstock. Slop tank class 110 is another type of the equipment class 112; however, from the system perspective, it is shown separately to indicate that inventory levels of slop may be monitored to automatically provide information on the percentage of slop contained in the feedstock.

Inspection report class 118 is a class that contains information reported by an operator or engineer on the condition of the refinery's equipment. This information is typically collected manually. The inspection activities typically follow a set of procedures or regulations that dictate what equipment needs to be inspected, how to perform the inspection, and the frequency of the inspections.

Maintenance report class 120 is a class that contains information reported by maintenance personnel on what service and/or repair was performed on the refinery's equipment. The maintenance activities typically follow a set of procedures or regulations that govern the state of condition of the equipment. This type of information may also be collected with the inspection data.

Production process class 122 is a class which contains information relating to the entire set of operations performed in the crude unit of the refinery to convert feedstock into the final products. The product refers to what is produced by the refinery including petrochemicals, gasoline, jet fuel, diesel, furnace oil, lubricants, bunker “C”, Number 6 oil, and asphalt. Product characteristics class 126 is a class which contains information relating to the chemical properties of the products produced by the crude unit.

Crude slate class 128 contains information relating to the composition of the raw feedstock that is processed by the refinery. The raw feedstock may consist of one or more crude oils and/or left over stock called slop. The system 100 captures and maintains the crude slate composition. The information includes the name of the crude oil or some unique identifier together with the percentage for each crude oil of the total raw feedstock. Slop may also be identified as part of the feedstock. Crude slate information may be entered to the system 100 as part of the service report or entered separately.

Crude oil class 130 describes the majority of the feedstock processed by the crude unit. The crude oil class 130 contains identifying information on the crude oil including the crude oil name, the location of the crude oil source, the producer of the crude oil, and such. Crude oil characteristics or assay class 132 contains information relating to the chemical properties of one or more crude oils, such as the crude oil contained in the crude tank. The system 100 provides provisions for more than one record to be stored so that the changes in the chemical characteristics may be tracked and trended over time.

Slop class 134 is a class which contains information relating to residual crude oil from previous process runs and/or remaining crude oil from the bottom of tanks that is mixed with crude oil and processed. The crude slate class 128 may contain information regarding slop in addition to crude oil.

Service report class 136 is a general class of information that may consist of crude slate information, production process information, non-destructive testing data, operational data, chemical treatment and problem reports. The field representative or service engineer creates and submits the service report, which is then updated and stored within the system 100 in the service report class 136.

NDT data class 138 is a class of information that may consist of time series data or data arrays of values collected from non-destructive testing. Operational data class 140 is a general class of information that indicates how the equipment was operated and how the equipment performed. Such indicators include controller output values that are either manually set by an operator or automatically set by a controller, sensor measurements and other instrument readings. The entries or instances for this class may have a timestamp associated with each value and a quality metric. The system 100 provides for both manually entered values as part of the service report and automatically collected values that are uploaded directly into the appropriate repository.

Chemical treatment class 142 contains information relating to the addition of one or more chemicals applied to the refinery process to minimize the effect of some adverse factor in the crude slate or to improve some aspect of a process. The system 100 captures and maintains the type of treatment, the chemical used in the treatment, the location of where the treatment was applied, and the dosage of the treatment. The system 100 provides for both manually entered values as part of the service report and automatically collected values that are uploaded directly into the appropriate repository.

Problem report class 144 contains information relating to certain events or observations identified as being an anomaly. The system 100 captures and maintains the type of problem, the location of the problem, operational data that further describes the conditions of the process, the severity of the problem, a description of the problem, and the resolution. The problem report for storing within the problem report class 144 may be entered as part of the service report or generated automatically by some monitoring and diagnostics application.

Laboratory analysis class 146 is a class which contains the results from performing chemical analysis on crude oils, slop, and/or crude oil products. The system 100 provides for maintaining such results, which may be used for further evaluation of refinery issues or root cause analysis of problems.

Laboratory simulation class 148 is a class which contains information relating to specialized tests performed in the laboratory that can simulate certain sub-processes of a refinery. For example, the corrosion rate may be determined for a specific crude oil in a certain type of piping material. The system 100 provides for maintaining such results, which may be used to predict potential problems with processing crude oils and to recommend the treatment plan to minimize such effects.

Predictive result class 150 represents the class of information that is generated by predictive analytics and/or a decision support system using information stored by the knowledge base 200 and/or external information. The system 100 provides for maintaining such results, which may be used by a field representative or service engineer to facilitate the selection of crude oils and to plan for treatment.

One or more of the predictive results stored by the hierarchical system can be displayed to the field representative or service engineer by a display of the system 100 upon the system 100 receiving a query. For example, the field representative may query the system 100 to determine if it is practical to use a specific refinery of the refinery class 104 to produce Number 6 oil of the product class 124 using a particular equipment configuration of the equipment configuration class 114. The system 100 accesses the predictive result class 150 and provides one or more predictive results, if sufficient information was provided to the system 100. If insufficient information was provided to the system 100, the system 100 can ask for additional information to be provided by the user.

In addition to providing a system for organizing the numerous classes of information in the hierarchical system, the invention prescribes methods for performing various functions, such as capturing the information, searching for information, reporting results, and updating the content by executing instructions by the at least one processor. The instructions can include information processing and/or database management instructions as known in the art. The following discussion describes the inventive methods using the system 100 in more detail.

The system 100 provides methods to create reports and store them in one or more of the report classes or to edit existing reports stored in the report classes. The types of reports include service report, problem report, inspection report, maintenance report, as well as other reports. The field representative or the service engineer typically creates these reports. The system 100 provides for web-based report creation and client-server-based report creation.

The system 100 provides methods to enter a new crude oil into the repository or to edit the information on an existing crude oil. The information includes crude oil identifying information such as crude name, origin, and geographical information and crude oil characteristics. The field representative or the service engineer may enter such information or the system 100 could automatically upload the information from a third party source. The system 100 maintains the previous information for trending and tracking.

The system 100 provides methods to enter new customer asset information or edit existing information. Customer assets and associated information includes refinery, equipment, equipment configuration, equipment specifications, and tank information. The field representative or the service engineer typically enters such information.

The system 100 provides methods to enter or edit operational data as part of the service report by the field representative or the service engineer. In addition, the system 100 provides methods to automatically collect data from controllers and data logger type equipment and upload such information into the repository.

The system 100 provides methods to enter or edit results from laboratory analyses and laboratory simulations. The system 100 provides for web-based methods.

The method to search for crude oil provides several means to find and retrieve specific crude oil information based on the following criteria: full or partial name or starts with a particular letter, geographical information such as state or province or country of origin, and other geographical information such as longitude, latitude, north or south hemisphere, and east or west hemisphere. The search results may contain one or more crude oils that match the search criteria.

The method to search for similar crude oils provides the means to find and retrieve crude oils that are close to the target crude oil based on a set of criteria. Each criterion has a range associated with it that represents the closeness. The search results may contain one or more crude oils that closely match the search criteria and are ranked in descending order by a closeness value.

The method to search by problem type provides the means to find and retrieve crude oils that cause certain problems during the production process. Other criteria may be included in the search. The search results may contain one or more crude oils that match the search criteria.

The method to search for refinery provides the means to find and retrieve refinery information based on the following criteria: refinery name or geographical location. The search results may contain one or more refineries that match the search criteria. The method to search for predictive engine results provides the means to find and retrieve such results.

The methods of the present disclosure may be interrelated such that one or more of the above-described methods are sub-methods of an overall method. For example, the present disclosure provides a method for receiving at least one query and searching for a particular crude oil, a similar crude oil, a problem type, refinery information relating to a specific refinery, and predictive engine results approximately satisfying the at least one query, where a sub-method is performed for determining the particular crude oil, the similar crude oil, and the problem type, and a sub-method is performed for obtaining the refinery information relating to the specific refinery, and predictive engine results. The determined particular crude oil, similar crude oil, and problem type, and the obtained refinery information relating to the specific refinery, and predictive engine results comprise data approximately satisfy the at least one query.

A method of the present disclosure also provides for validating data or values inputted to the refinery and crude oil knowledge management system 100 and associated with at least one class of the plurality of classes. To be able to validate values, the system 100 stores predefined ranges for various parameters, such as pH range of crude oil, and the minimum and maximum amount of slop and crude oil contained in the feedstock. Once the system 100 receives values, the at least one processor compares the received values with the stored predefined ranges. If the received values are within the stored predefined ranges, the system 100 informs the user by a message and/or audible alarm that the values are proper for the specific refinery and/or application to be performed. If the received values are not within the stored predefined ranges, the system 100 informs the user by another message and/or audible alarm that the values are not proper for the specific refinery and/or application to be performed.

For example, in one specific application to be performed by the refinery, the pH of a crude oil needs to be within the predefined range of about 3.0 to about 6.5. If a user inputs to the system 100 a pH value outside this predefined range, the system 100 alerts the user by a message and/or audible sound that the received pH value is outside the predefined range and the specific application may not be possible or may not be performed efficiently. A set of programmable instructions are provided to the system 100 for execution by the at least one processor for performing the data validation method.

The described embodiments of the present disclosure are intended to be illustrative rather than restrictive, and are not intended to represent every embodiment of the present disclosure. Various modifications and variations can be made without departing from the spirit or scope of the present disclosure as set forth in the following claims both literally and in equivalents recognized in law.

1. A refinery and crude oil knowledge management system comprising:
a knowledge base storing a plurality of classes of information related at least to a specific refinery, a collection of equipment for processing crude oils, and a set of operations performed by the collection of equipment to produce crude oil products, each of the plurality of classes of information are associated with or related to each other and organized in a hierarchical system; and
a set of programmable instructions configured for execution by at least one processor for accessing at least one class of the plurality of classes for accessing and disseminating information in response to at least one query, said disseminated information including at least one of crude oil characterizations, experiences of processing crude oils in the refinery, problems encountered during the processing of crude oil in the refinery, and the treatments applied by personnel of the refinery to counteract those problems, said disseminated information facilitating decision-making, risk management of processing crude oils, and the planning and monitoring of chemical treatments applied to the specific refinery's crude oil production processes.

2. The knowledge management system in accordance with claim 1, wherein the plurality of classes of information comprises:
a customer class containing information relating to an owner of the specific refinery;
a refinery class containing information relating to the specific refinery; and
a crude unit class containing information relating to the collection of equipment for processing crude oil;
a crude tank class containing information relating to the amount of crude oil contained in a feedstock of the specific refinery;
a slop tank class containing information relating to the amount of slop contained in the feedstock;
an equipment configuration class containing information relating to the arrangement of systems, subsystems and components of the collection of equipment; and
an equipment specification class which includes design information relating to the specific refinery.

3. The knowledge management system in accordance with claim 2, wherein the equipment configuration and equipment specification classes are sub-classes of an equipment class within the hierarchical system, and wherein the crude tank and slop tank classes are sub-classes of the crude unit class within the hierarchical system.

4. The knowledge management system in accordance with claim 1, wherein the plurality of classes of information comprises:
a product class containing information relating to at least one product produced by the specific refinery;
a product characteristics class containing information relating to the chemical properties of the at least one product produced;
a crude slate class containing information relating to the composition of raw feedstock processed by the specific refinery;
a crude oil characteristics class containing information relating to the chemical properties of one or more crude oils;
a crude oil class containing information relating to a majority of a feedstock processed by a crude unit of the specific refinery;
a production process class containing information relating to a set of operations performed in the crude unit to convert feedstock into products; and
a slop class containing information relating to residual crude oil from previous process runs and/or remaining crude oil from tanks that is mixed with crude oil and processed.

5. The knowledge management system in accordance with claim 4, wherein the crude oil and slop classes are sub-classes of the crude slate class within the hierarchical system, wherein the crude oil characteristics class is a sub-class of the crude slate class within the hierarchical system, and wherein the product and crude slate classes are a sub-classes of the production process class within the hierarchical system.

6. The knowledge management system in accordance with claim 1, wherein the plurality of classes of information comprises:
an inspection report class containing information reported by an operator on the condition of refinery equipment;
a maintenance report class containing information reported by maintenance personnel on a service and/or repair performed on refinery equipment;
a service report class containing information selected from the group consisting of crude slate information, production process information, non-destructive testing data, operational data, chemical treatment and problem reports; and
a problem report class containing information relating to at least one identified problem; and
an operational data class containing information relating to equipment performance;
a non-destructive testing class containing information collected from non-destructive testing; and
a chemical treatment class containing information related to one or more chemicals applied to a refinery process.

7. The knowledge management system in accordance with claim 6, wherein the operation data, inspection, and maintenance classes are sub-classes of an equipment class within the hierarchical system, wherein the non-destructive testing class is a sub-class of a production process class and a crude slate class, and wherein the chemical treatment class is a sub-class of the service report class which in turn is a sub-class of the production process class within the hierarchical system.

8. The knowledge management system in accordance with claim 1, wherein the plurality of classes of information comprises:
a laboratory analysis class containing results of performed chemical analysis on crude oils, slop, and/or crude oil products;
a laboratory simulation class pertaining to laboratory tests simulating sub-processes of the specific refinery; and
a predictive result class containing information that is generated by predictive analytics and/or a decision support system.

9. A computer readable medium storing a set of instructions configured for execution by at least one processor for performing the steps of:
searching a knowledge base storing a plurality of classes of information related at least to a specific refinery, a collection of equipment for processing crude oils, and a set of operations performed by the collection of equipment to produce crude oil products, each of the plurality of classes of information are associated with or related to each other and organized in a hierarchical system; and
accessing at least one class of the plurality of classes for obtaining and disseminating information in response to at least one query, said disseminated information including at least one of crude oil characterizations, experiences of processing crude oils in the refinery, problems encountered during the processing of crude oil in the refinery, and the treatments applied by personnel of the refinery to counteract those problems, said disseminated information facilitating decision-making, risk management of processing crude oils, and the planning and monitoring of chemical treatments applied to the specific refinery's crude oil production processes.

10. The computer readable medium in accordance with claim 9, wherein the plurality of classes of information comprises:
a customer class containing information relating to an owner of the specific refinery;
a refinery class containing information relating to the specific refinery; and
a crude unit class containing information relating to the collection of equipment for processing crude oil;
a crude tank class containing information relating to the amount of crude oil contained in a feedstock of the specific refinery;
a slop tank class containing information relating to the amount of slop contained in the feedstock;
an equipment configuration class containing information relating to the arrangement of systems, subsystems and components of the collection of equipment; and
an equipment specification class which includes design information relating to the specific refinery.

11. The computer readable medium in accordance with claim 10, wherein the equipment configuration and equipment specification classes are sub-classes of an equipment class within the hierarchical system, and wherein the crude tank and slop tank classes are sub-classes of the crude unit class within the hierarchical system.

12. The computer readable medium in accordance with claim 9, wherein the plurality of classes of information comprises:
a product class containing information relating to at least one product produced by the specific refinery;
a product characteristics class containing information relating to the chemical properties of the at least one product produced;
a crude slate class containing information relating to the composition of raw feedstock processed by the specific refinery;
a crude oil characteristics class containing information relating to the chemical properties of one or more crude oils;
a crude oil class containing information relating to a majority of a feedstock processed by a crude unit of the specific refinery;
a production process class containing information relating to a set of operations performed in the crude unit to convert feedstock into products; and
a slop class containing information relating to residual crude oil from previous process runs and/or remaining crude oil from tanks that is mixed with crude oil and processed.

13. The computer readable medium in accordance with claim 12, wherein the crude oil and slop classes are sub-classes of the crude slate class within the hierarchical system, wherein the crude oil characteristics class is a sub-class of the crude slate class within the hierarchical system, and wherein the product and crude slate classes are a sub-classes of the production process class within the hierarchical system.

14. The computer readable medium in accordance with claim 9, wherein the plurality of classes of information comprises:
an inspection report class containing information reported by an operator on the condition of refinery equipment;
a maintenance report class containing information reported by maintenance personnel on a service and/or repair performed on refinery equipment;
a service report class containing information selected from the group consisting of crude slate information, production process information, non-destructive testing data, operational data, chemical treatment and problem reports; and
a problem report class containing information relating to at least one identified problem; and
an operational data class containing information relating to equipment performance;
a non-destructive testing class containing information collected from non-destructive testing; and
a chemical treatment class containing information related to one or more chemicals applied to a refinery process.

15. The computer readable medium in accordance with claim 14, wherein the operation data, inspection, and maintenance classes are sub-classes of an equipment class within the hierarchical system, wherein the non-destructive testing class is a sub-class of a production process class and a crude slate class, and wherein the chemical treatment class is a sub-class of the service report class which in turn is a sub-class of the production process class within the hierarchical system.

16. The computer readable medium in accordance with claim 9, wherein the plurality of classes of information comprises:
a laboratory analysis class containing results of performed chemical analysis on crude oils, slop, and/or crude oil products;
a laboratory simulation class pertaining to laboratory tests simulating sub-processes of the specific refinery; and
a predictive result class containing information that is generated by predictive analytics and/or a decision support system.

17. A method for managing information stored within a refinery and crude oil knowledge management system comprising a knowledge base storing a plurality of classes of information related at least to a specific refinery, a collection of equipment for processing crude oils, and a set of operations performed by the collection of equipment to produce crude oil products, each of the plurality of classes of information are associated with or related to each other and organized in a hierarchical system, and a set of programmable instructions configured for execution by at least one processor for accessing at least one class of the plurality of classes in response to at least one query, said method comprising the steps of:
disseminating information relating to the at least one class accessed in response to the at least one query, and
entering and storing data within at least one class of the plurality of classes, including data related to laboratory analysis and simulations.

18. The method in accordance with claim 17, wherein said disseminated information including at least one of crude oil characterizations, experiences of processing crude oils in the refinery, problems encountered during the processing of crude oil in the refinery, and the treatments applied by personnel of the refinery to counteract those problems, and wherein said disseminated information facilitating decision-making, risk management of processing crude oils, and the planning and monitoring of chemical treatments applied to the specific refinery's crude oil production processes.

19. The method in accordance with claim 17, wherein the step of disseminating information includes the steps of creating and editing reports.

20. The method in accordance with claim 17, wherein the plurality of classes of information comprises:
a customer class containing information relating to an owner of the specific refinery;
a refinery class containing information relating to the specific refinery; and
a crude unit class containing information relating to the collection of equipment for processing crude oil;
a crude tank class containing information relating to the amount of crude oil contained in a feedstock of the specific refinery;
a slop tank class containing information relating to the amount of slop contained in the feedstock;
an equipment configuration class containing information relating to the arrangement of systems, subsystems and components of the collection of equipment; and
an equipment specification class which includes design information relating to the specific refinery.

21. The method in accordance with claim 20, wherein the equipment configuration and equipment specification classes are sub-classes of an equipment class within the hierarchical system, and wherein the crude tank and slop tank classes are sub-classes of the crude unit class within the hierarchical system.

22. The method in accordance with claim 17, wherein the plurality of classes of information comprises:
a product class containing information relating to at least one product produced by the specific refinery;
a product characteristics class containing information relating to the chemical properties of the at least one product produced;
a crude slate class containing information relating to the composition of raw feedstock processed by the specific refinery;
a crude oil characteristics class containing information relating to the chemical properties of one or more crude oils;
a crude oil class containing information relating to a majority of a feedstock processed by a crude unit of the specific refinery;
a production process class containing information relating to a set of operations performed in the crude unit to convert feedstock into products; and
a slop class containing information relating to residual crude oil from previous process runs and/or remaining crude oil from tanks that is mixed with crude oil and processed.

23. The method in accordance with claim 22, wherein the crude oil and slop classes are sub-classes of the crude slate class within the hierarchical system, wherein the crude oil characteristics class is a sub-class of the crude slate class within the hierarchical system, and wherein the product and crude slate classes are a sub-classes of the production process class within the hierarchical system.

24. The method in accordance with claim 17, wherein the plurality of classes of information comprises:
an inspection report class containing information reported by an operator on the condition of refinery equipment;
a maintenance report class containing information reported by maintenance personnel on a service and/or repair performed on refinery equipment;
a service report class containing information selected from the group consisting of crude slate information, production process information, non-destructive testing data, operational data, chemical treatment and problem reports; and
a problem report class containing information relating to at least one identified problem; and
an operational data class containing information relating to equipment performance;
a non-destructive testing class containing information collected from non-destructive testing; and
a chemical treatment class containing information related to one or more chemicals applied to a refinery process.

25. The method in accordance with claim 24, wherein the operation data, inspection, and maintenance classes are sub-classes of an equipment class within the hierarchical system, wherein the non-destructive testing class is a sub-class of a production process class and a crude slate class, and wherein the chemical treatment class is a sub-class of the service report class which in turn is a sub-class of the production process class within the hierarchical system.

26. The method in accordance with claim 17, wherein the plurality of classes of information comprises:
a laboratory analysis class containing results of performed chemical analysis on crude oils, slop, and/or crude oil products;
a laboratory simulation class pertaining to laboratory tests simulating sub-processes of the specific refinery; and
a predictive result class containing information that is generated by predictive analytics and/or a decision support system.

27. A method for searching a refinery and crude oil knowledge management system for obtaining data, said management system comprising a knowledge base storing a plurality of classes of information related at least to a specific refinery, each of the plurality of classes of information are associated with or related to each other and organized in a hierarchical system, and a set of programmable instructions configured for execution by at least one processor for accessing at least one class of the plurality of classes, said method comprising the steps of:
receiving at least one query by said crude oil knowledge management system, said at least one query specifying data for at least one class of the plurality of classes;
accessing the at least one class of the plurality of classes and locating data approximately satisfying the at least one query; and
outputting the located data approximately satisfying the at least one query.

28. A method for validating data received by a refinery and crude oil knowledge management system comprising a knowledge base storing a plurality of classes of information related at least to a specific refinery, each of the plurality of classes of information are associated with or related to each other and organized in a hierarchical system, and a set of programmable instructions configured for execution by at least one processor for validating data associated with at least one class of the plurality of classes, said method comprising the steps of:
comparing the received data with data stored within the refinery and crude oil knowledge management system;
determining if the received data are within at least one predefined range; and
performing at least one action indicating whether the received data are within the at least one predefined range.
